(19) United States
(12) Patent Application Publication
(10) Pub. No.: US 2012/0103540 A1
(43) Pub. Date: May 3, 2012

(54) Window Treatment With Spatially Varied Transparency

(76) Inventors: Kris Shaffer, Newton, MA (US); Lee Weinstein, Arlington, MA (US)

(21) Appl. No.: 12/912,742

(22) Filed: Oct. 27, 2010

(51) Int. Cl. E06B 9/24

(52) U.S. Cl. 160/237

(57) ABSTRACT

A window treatment is disclosed that offers privacy while also allowing persons within a residence to look outside. The window treatment utilizes a fabric manufactured to have a transparency constant across its horizontal dimension, and varying across its vertical dimension.

### FIELD OF THE INVENTION

The field of the invention relates to window curtains, window shades, and more specifically to window treatments with spatially varied transparency.

### BACKGROUND OF THE INVENTION

Within most residences, most windows are equipped with window treatments such as shades, blinds, curtains, shutters, or some combination of such window treatments. Many window treatments are designed to be aesthetically pleasing as well as serving one or more functions. Completely opaque (non-transparent) shades are designed to block sunlight from entering a room (for instance, to facilitate sleeping during day light hours). Most window shades and curtains (when drawn) provide a privacy function, preventing persons on the outside of a residence from seeing into the residence. Some window shades and curtains are translucent, allowing some (typically up to 50% of external light to pass through, while scattering the light so that while persons standing on one side of the shade or curtain can see light coming from the other side, no visual image of what is on the other side can be discerned. The louvers of louvered blinds can be adjusted to provide transparency, translucency, or complete opaqueness, depending on the material of which the louvers are made and the angle to which the louvers are adjusted.

In addition to having adjustable louver angle and overlap, most blinds can also be raised and lowered in a manner similar to shades. Most blinds and shades are deployed from the top of the window downward, so partially deployed blinds typically leave the lower part of a window optically un-obscured. In order to better provide privacy with partly deployed shades and blinds, some manufacturers make shades and blinds that are deployed from the bottom of the window upward, so that when the shade or blind is partly deployed, the upper part of the window is optically unobscured. While such shades function well in the partially-deployed state to provide privacy, they are often considered less attractive in their non-deployed state, because they can interfere with a person's ability to open the bottom sash of a window, and they can interfere with seeing out the bottom of the window.

To enhance privacy without interfering physically or optically with the bottom window sash, some manufacturers have made available indoor shutters, which sit folded to the sides of the window in their undeployed state. The space required to swing shutters open or closed may be a disadvantage in situations where furniture is near a window, and shutters are considered by many not to be aesthetically pleasing.

There is a need for innovative window treatments which can provide adjustable or spatially varied amounts of transparency to facilitate privacy. There is a further need for innovative window treatments which can provide adjustable or spatially varied amounts of transparency to facilitate privacy, while leaving the lower sash of a window unobscured when the window treatment is in the un-deployed state. There is a further need for innovative window treatments which can provide adjustable or spatially varied amounts of transparency in a manner that is aesthetically pleasing.

### SUMMARY OF THE INVENTION

The present invention utilizes fabric which is manufactured to have a spatially varying average transparency along one dimension and a spatially constant average transparency along the perpendicular dimension, within the plane of the fabric. In one aspect of the present invention, such fabric is produced as a bolt of fabric with a transparency that varies from one selvage of the fabric bolt to the other. The present invention provides several designs for window treatments which can provide vertically varied transparency, for instance such that in the deployed state, the window treatment is less transparent toward the bottom of the window and more transparent toward the top of the window.

In one aspect, the present invention uses fabric with a spatially varied thread density to provide the selvage-to-selvage variation in transparency. In another aspect, the present invention utilizes a base sheer fabric with a consistent transparency, and a secondary material applied to the base fabric such that the transparency of the composite fabric varies from one selvage to the other. In a third aspect, the present invention utilizes a fabric which has sheer regions and non-sheer regions that alternate where the percentage of sheer regions varies from one selvage of the fabric to the other.

In one preferred embodiment, curtains or a shade may be made from a woven fabric which is manufactured to have a vertical thread count (count of horizontal threads per vertical inch) which is substantially higher at the lower end of a deployed shade or curtain than at the upper end. Thus the upper part of the window is covered by a more sheer fabric than the lower part of the window.

In a preferred embodiment of a shade according to the present invention, in the un-deployed state, fabric is rolled onto a roller at the top of the window. The fabric has a consistent horizontal thread count (count of vertical threads per inch, counted in the horizontal direction) across the shade, but has a higher vertical thread count (count of horizontal threads per inch, counted in the vertical direction) toward the bottom of the shade compared with the top of the shade.

In an alternate preferred embodiment of a shade according to the present invention, an additional lower-end roller or folding mechanism may be provided such that in the deployed state, a given horizontally consistent region of a given transparency or opacity may be moved up and down within the window area to provide a variable variable-height privacy transition (where the privacy transition height is the height at which the transparency becomes low enough that what is on the other side of the fabric is no longer discernable from a distance.

### BRIEF DESCRIPTION OF THE DRAWINGS

FIG. 1 is a magnified photograph of a sample of highly sheer fabric.

FIG. 2 is a magnified photograph of a sample of medium sheer fabric.

FIG. 3 is a magnified photograph of a sample of tight-woven (non-sheer) fabric.

FIG. 4 is a perspective-view magnified photograph of a sample of tight-woven (non-sheer) fabric.

FIG. 5 is a simulated photo of a window treatment according to the present invention.

FIG. 6A is a photograph of a partially sheer fabric laying on a table top.

FIG. 6B is a photograph looking through the partially sheer fabric of FIG. 6A.

FIG. 7A is a photograph of a partially sheer fabric laying on a table top.

FIG. 7B is a photograph looking through the partially sheer fabric of FIG. 7A.

FIG. 8 is a photograph of a partially sheer fabric laying on a table top.

FIG. 9 is a photograph of a partially sheer fabric laying on a table top.

FIG. 10A is a photograph of a partially sheer fabric laying on a table top.

FIG. 10B is a photograph looking through the partially sheer fabric of FIG. 10A.

FIG. 11 is a photograph taken through a partially sheer fabric.

FIG. 12 is a photograph taken through a partially sheer fabric made from a base sheer fabric with doughnut-shaped non-sheer regions of material applied to the fabric in the manufacturing process.

FIG. 13 is a photograph taken through a partially sheer fabric.

### DETAILED DESCRIPTIONS OF SOME PREFERRED EMBODIMENTS

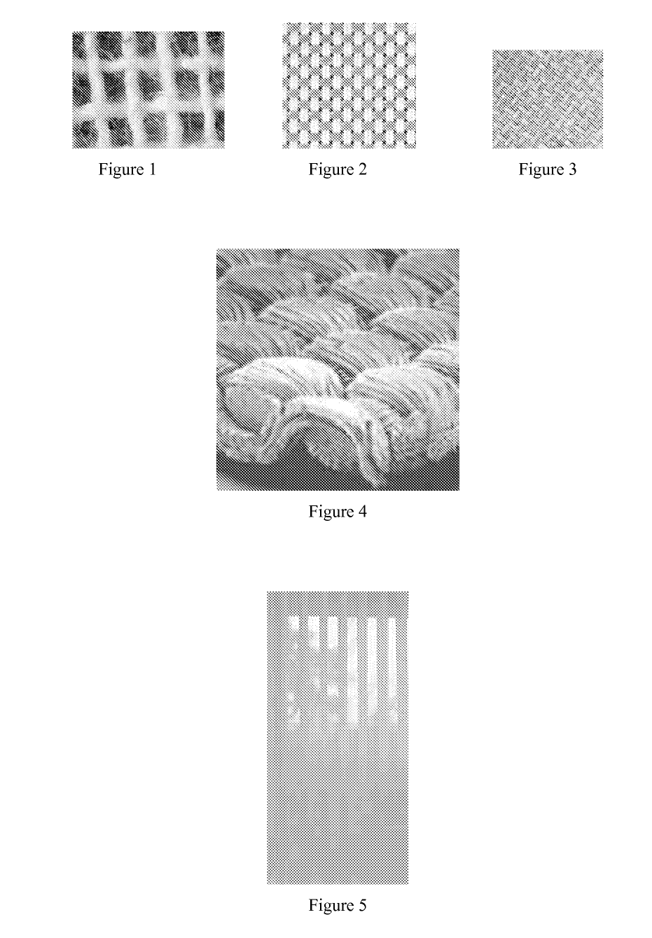

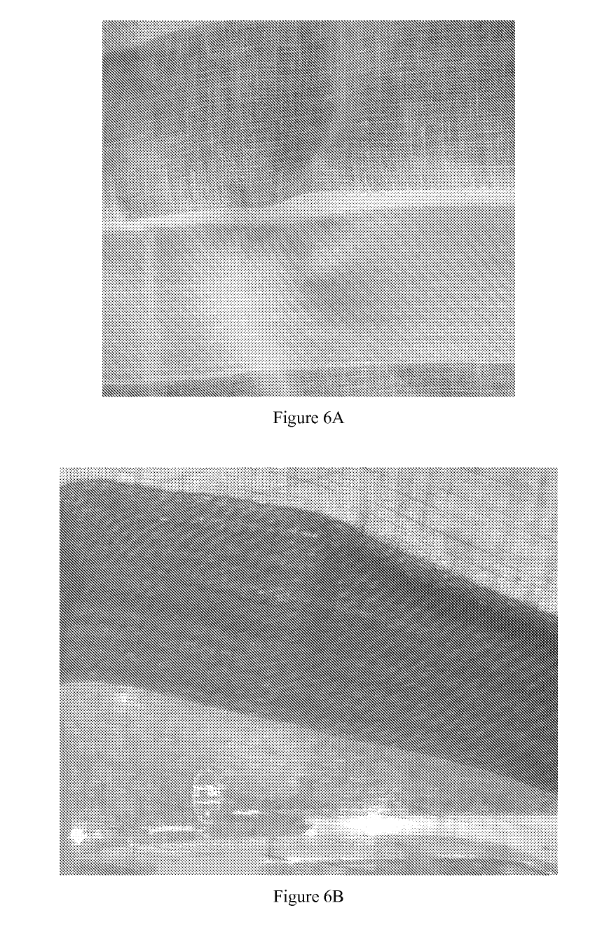

Within this document, the degree to which a fabric shall be described as “sheer” or “transparent” shall be deemed to be indicative of the degree to which an object on the opposite side of such fabric can be discerned by a person looking through the fabric. FIG. 1 is a magnified photograph of a sample of highly sheer fabric. It can be seen that roughly half of the surface area of the fabric consists of fiber, and roughly half of the surface area of the fabric consists of the space between the fibers, through which light can pass unimpeded. FIG. 2 is a magnified photograph of a sample of medium sheer fabric. It can be seen that roughly half of the surface area of the fabric consists of fiber, and roughly 10% of the surface area of the fabric consists of the space between the fibers, through which light can pass unimpeded.

Woven fabric has traditionally been manufactured in long rolls called bolts. Traditionally bolts have typically been 54″ wide, with the edges of this dimension referred to in the art as selvages. The threads that run from one selvage to the other are known in the art as weft or woof threads. In recent years some fabrics have become available in formats up to 130″ in wide, sometimes folded lengthwise and rolled onto a narrower bolt roll. Wide-format fabrics woven according to the present invention particularly well suited for some preferred embodiments of the present invention. In such embodiments, the count per inch or threads which are oriented perpendicular to the axis of the bolt (known in the art as warp threads) varies from one selvage to the other, and the vertical dimension of the window treatments made from such a bolt of fabric corresponds to the dimension parallel to the axis of the bolt when the fabric is manufactured. Warp threads run the full length of the bolt (generally about 60-100 yards).

FIG. 5 depicts fabric according to the present invention combined with vertical blinds. The horizontal dimension in the photograph corresponds to the dimension of the fabric perpendicular to the axis of the bolt of fabric as it is manufactured, and the vertical dimension in the photo corresponds to a subsection of the width of the bold of fabric. The vertical thread density is higher near the bottom, so the window treatment is less transparent near the bottom. In this example, transparency in the bottom 20% of the fabric is zero, though translucency in the bottom 20% is still significant.

Within this document, the term “translucence” shall refer to light passing through an object (in this case a fabric), but being scattered on the way through. Thus there is no correlation between the direction of photons entering the material and photons leaving the material, so objects cannot be discerned when looking through the material, only the presence and quantity of light on the other side of the material can be perceived. Even a fabric tightly woven of transparent threads will appear translucent rather than transparent, because each fiber will act like a cylindrical lens, changing the direction of each photon of light passing through the fabric. Fabrics woven with varying fiber spacing may have spatially varying translucency, or spatially varying transparency, depending on whether the weave is loose enough to have space between the threads.

Within this document, the term “window treatment” shall be construed to include window shades, curtains, and blinds (whether vertical or horizontal). Within this document, a window treatment will be considered “deployed” on a window within a residence when a person standing within the residence would have to see through the window treatment in order to see out through the window. Within this document, the term “vertical thread count” shall be construed to mean the count of horizontal threads per vertical inch.

Within this document, the term “transparency” shall be construed to mean the percentage of surface area of a fabric through which light can pass through perpendicular to the plane of said fabric unimpeded. Within this document, the term “translucency” shall be construed to mean the percentage of light which passes through a fabric, but is scattered while passing through.

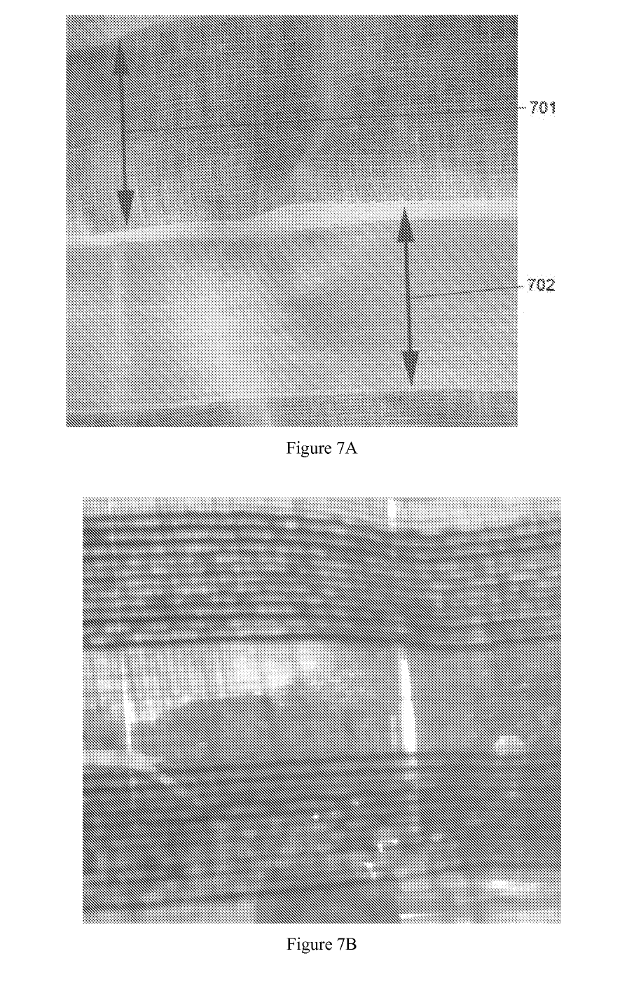

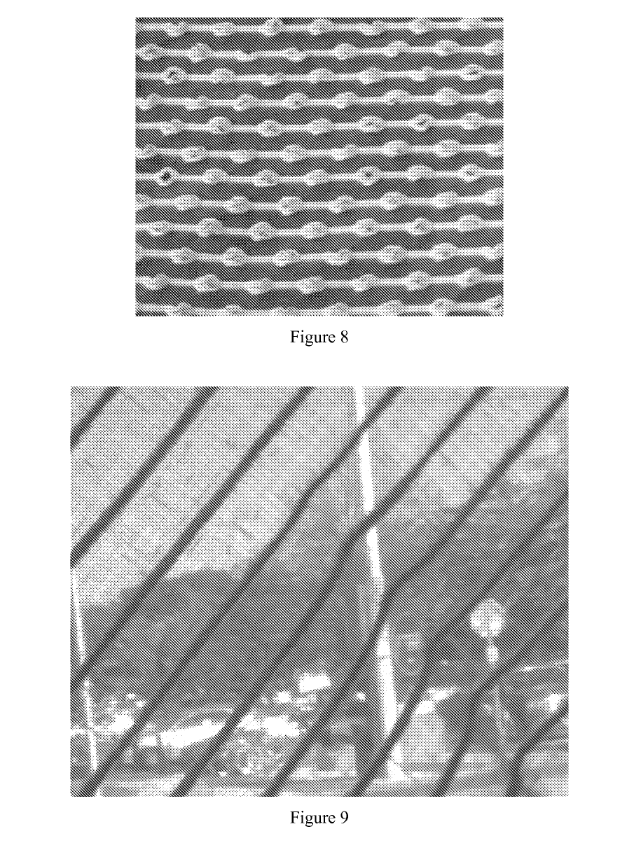

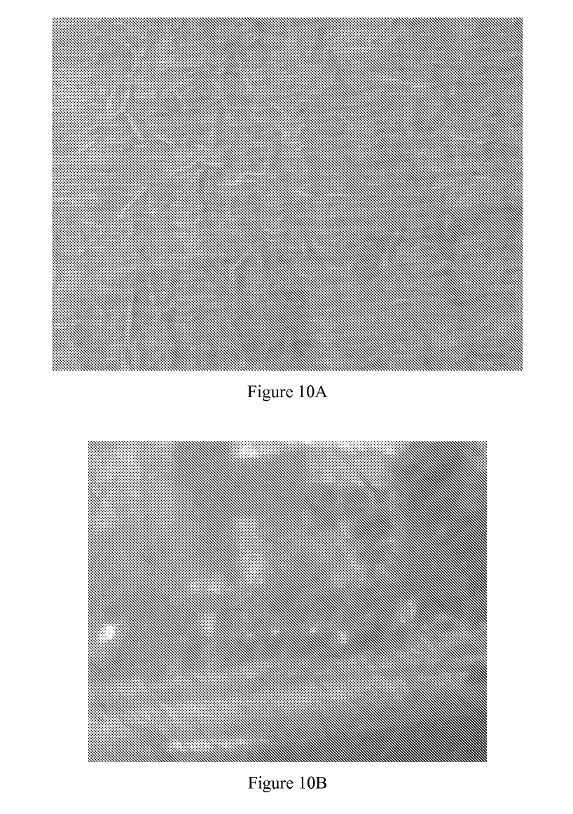

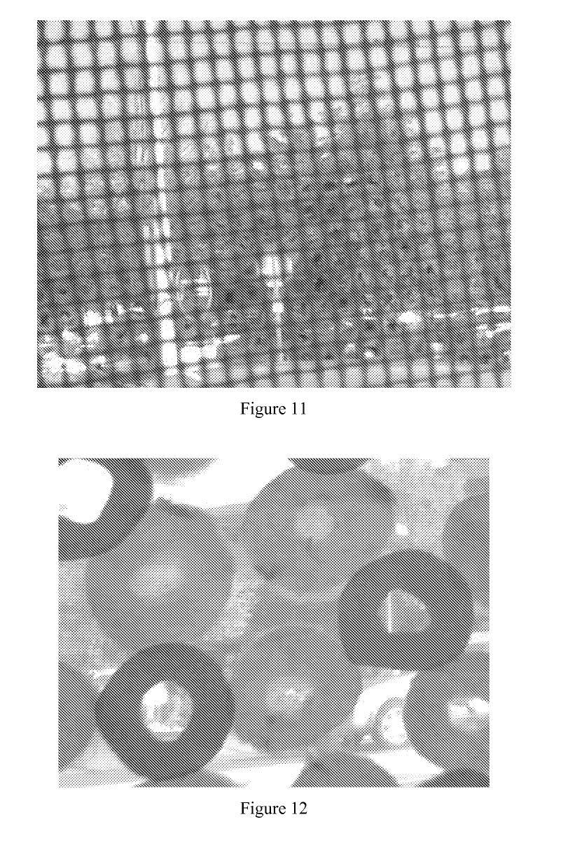

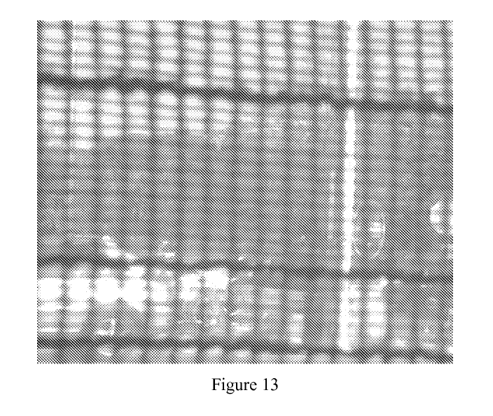

FIG. 7A is a photograph of a commercially available partially sheer fabric laying on a table top. FIG. 7B is a photograph looking through the partially sheer fabric of FIG. 7A. A modified version of such a fabric (where sheer and non-sheer regions alternate from one selvage to the other) may be manufactured according to the present invention by varying the width 702 of the interleaved non-sheer regions from selvage to selvage as the fabric is manufactured, or varying the width of the sheer 701 of the sheer regions from selvage to selvage as the fabric is manufactured, or both, such that the fabric is more transparent on the average in a region close to one selvage than it is at a region close to the other selvage.

FIG. 12 is a photograph taken through a partially sheer fabric made from a base sheer fabric with donut-shaped non-sheer regions of material applied to the fabric in the manufacturing process. A modified version of such a fabric may be manufactured according to the present invention by varying the spatial density of the applied donut-shaped regions from one selvage to the other, such that the fabric is on the average more transparent in a region close to one selvage than in a region close to the other selvage.

It is understood that statistical variations in normal commercial fabric manufacturing processes produce fabrics whose transparency varies by a percent or two from one selvage to the other. In the aspect of the present invention that concerns manufacturing a bolt of fabric where the transparency of the fabric is designed to vary from one selvage of the bolt to the other, the present invention is concerned with fabrics whose transparency varies considerably more than statistical variations, and whose transparency is significantly more consistent along the bolt than it is from selvage to selvage.

The foregoing discussion should be understood as illustrative and should not be considered to be limiting in any sense. While this invention has been particularly shown and described with references to preferred embodiments thereof, it will be understood by those skilled in the art that various changes in form and details may be made therein without departing from the spirit and scope of the invention as defined by the claims.

What is claimed is:

1. A window treatment comprising a fabric with a transparency constant in the horizontal dimension, and varying in the vertical dimension when said window treatment is deployed in a window.

2. The window treatment of claim 1, wherein said fabric comprises a knitted fabric.

3. The window treatment of claim 1, wherein said fabric comprises a woven fabric.

4. The window treatment of claim 3, wherein the vertical thread count of said fabric varies from top to bottom of said window treatment when said window treatment is deployed in said window.

5. The window treatment of claim 4, wherein the vertical thread count of said window treatment is higher at the bottom of said window treatment than at the top of said window treatment when said window treatment is deployed in said window.

6. The window treatment of claim 1, wherein said fabric comprises a fabric of consistent transparency, with additional material applied to said fabric in a spatially varying density to form a composite fabric such that the transparency of the composite fabric varies along the vertical dimension of said window treatment

7. A window treatment comprising a fabric with a translucency constant in the horizontal dimension, and varying in the vertical dimension when said window treatment is deployed in a window.

8. A bolt of fabric, manufactures such that the average transparency of said fabric varies by more than five percent from one selvage of said fabric to the opposite selvage.

9. The bolt of fabric of claim 8, where the average transparency (taken over a four inch by four inch square) of said fabric varies by more than five percent from one selvage of said fabric to the opposite selvage.

10. The bolt of fabric of claim 9, manufactured by varying the spacing of alternating regions of less-transparent fabric with regions of more transparent fabric from one selvage to the other, where said regions are arranged in a striped pattern where the stripes of said pattern run the length of said bolt (in the direction perpendicular to the selvage-to-selvage direction).

11. The bolt of fabric of claim 9, manufactured as a composite fabric comprising a base fabric of homogeneous transparency, with applied regions of material bonded to said fabric in such that the spatial density of said bonded regions varies from one selvage of said fabric to the other.
